(19) United States
(12) Patent Application Publication
(10) Pub. No.: US 2004/0052688 A1
(43) Pub. Date: Mar. 18, 2004

(54) Cover for vessels or systems for reducing the evaporation and/or the introduction of gases

(76) Inventors: Enno Adema, Heidelberg (DE); Michael-Harold Town, Oberhausen (DE)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/343,631

(22) PCT Filed: Jul. 31, 2001
(86) PCT No.: PCT/EP01/08832

(30) Foreign Application Priority Data
Aug. 5, 2000 (DE) 100 38 351.3
Aug. 5, 2000 (DE) 100 38 350.5

(51) Int. Cl. B01L 3/00

(52) U.S. Cl. 422/99; 215/296

(57) ABSTRACT

Cover for vessels to reduce the evaporation of a liquid from a vessel and/or the introduction of gases, especially carbon dioxide, into a liquid in a vessel, wherein the cover has at least one opening through which a pipette or the like can be inserted into the inside of the vessel and the cover also contains an active material or a material that can be activated, that releases moisture and/or absorbs gas or which is suitable for taking up a liquid that can release moisture or absorb gas. System for storing liquids comprising a vessel and a cover that is attached to the vessel. System comprising a vessel storage space on the opening of which a cover of the afore-mentioned type is mounted.

### BACKGROUND OF THE INVENTION

The present invention relates to the storage of liquids and in particular of reagent liquids that are commonly used in the diagnostic field.

The invention concerns covers for vessels to reduce the evaporation of a liquid from a vessel and/or the introduction of gases, especially carbon dioxide, into a liquid in the vessel. The cover has an opening through which a pipette or the like can be inserted into the inside of the vessel. The cover also contains a material which releases moisture and/or absorbs gas. The invention also concerns systems with such covers.

It is known from the daily routine in the field of analytics and especially of automated clinical diagnostics that evaporation from vessels which contain reagents, sample material or the like can lead to a falsification of the analytical results. The evaporation concentrates the components of the liquid which can result in analytical errors especially when the concentration of the components has a direct influence on the analytical result such as in titration methods. Another problem is that opened vessels can absorb gases from the environment. In particular the absorption of carbon dioxide by alkaline liquids from the ambient air can result in serious analytical errors. This is primarily the case when the reagent liquid is to be used to determine carbon dioxide in an analytical liquid (e.g. blood or serum).

A number of measures are known in the prior art for reducing evaporation from vessels or the introduction of carbon dioxide. A known procedure is for example to open the vessels to withdraw liquid and close them again immediately after the withdrawal. However, such an opening and closing which is for example described in WO 96/09504 considerably complicates the instrument. In addition it requires a software to coordinate the opening and closing processes as well as the withdrawal processes.

Another approach for reducing evaporation or the introduction of gases is to reduce the cross-section of interaction between the gas space and liquid surface. For this purpose so-called chimneys are described in the documents U.S. Pat. No. 5,102,631, DE 3838278 and WO 97/12677 which are introduced into the opening of a vessel. These chimneys limit the interaction between the liquid and gas space to the narrow cross-section of the chimney. An advantage of this procedure is that the objective can be achieved by simple means, and vessels prepared in this manner are accessible for pipetting processes at any time. However, a disadvantage of using chimneys is that evaporation and the absorption of gases still take place via the liquid in the chimney.

It is also known from the prior art that evaporation can be reduced from sample or reagent vessels by providing channels filled with liquid in the interior of an analyzer from which liquid evaporates and thus creates an adequate air humidity. However, such an arrangement as described in U.S. Pat. No. 3,942,952 has the disadvantage that liquid can easily be splashed when the instrument is for example transported or knocked which interferes with the analysis.

### SUMMARY OF THE INVENTION

The object of the present invention was to propose a simple device which can be used to effectively reduce evaporation from vessels or the uptake of gases into a liquid in a vessel. A device according to the invention should in particular be cheap and if possible not require any changes to the hardware or software of an analyzer.

These objects are achieved by a cover for vessels or systems which has an opening through which a pipette can be inserted into the inside of the vessel, and the cover releases moisture and/or absorbs gas. Covers according to the invention can be combined with a vessel to form a system for storing liquids or be mounted on a system, especially an analytical system.

Such an analytical system has a storage space for holding at least one vessel. A cover according to the invention with at least one opening is mounted on the storage space and gas flows through the cover when gas is exchanged between the inside of the storage space and the outer space. It is important that gas exchange between the storage space and the outer space is essentially limited to an exchange through this opening so that evaporation or the entry of gases does not take place via other routes.

It is also advantageous within the scope of the present invention to only provide one opening or no more than a few openings in the system with the storage space and to transport vessels from which liquid is to be withdrawn to a position within the storage space at which the vessel can be accessed through an opening. Hence the system preferably has a corresponding transport device for vessels. A rotor on which vessels are arranged is preferably located within the storage space and can be used to sequentially move the vessels into suitable withdrawal positions.

Covers according to the present invention are intended to be attached to a vessel opening or to the opening of a storage space for holding at least one vessel in such a manner that the inner space can only communicate with the outer space through the opening in the cover. Hence gas which enters or leaves the vessel by diffusion or convection crosses the area of the opening. During this passage through the opening the gas can be enriched with moisture or components such as carbon dioxide in particular can be removed from it. The cover has a beneficial effect even when there is essentially no air movement by releasing moisture into the neighbouring air which is in turn in diffusion exchange with the inner space of the vessel.

The opening in the cover according to the invention has the shape of a channel which connects the inner space of the vessel with the outer space. The interaction of the cover with the gas space is primarily via the walls of this channel but can also alternatively or in addition take place via the underside of the cover facing the interior of the vessel. In order to achieve an adequate exchange path the channel should have a length of more than 4 mm. The channel preferably has a length of 0.8−2.5 cm. If the channel is very narrow (≦0.4 cm), an exchange path which is shorter than 4 mm may be adequate. The cross-section of the channel should be as small as possible to reduce convection currents but large enough to allow a pipette to pass through it in order to withdraw liquid. Channel diameters between 0.4 and 1.3 cm have proven to be advantageous.

A material is present in the cover which releases moisture and/or absorbs gas or is suitable for taking up liquids which fulfil these purposes. In the former case the material is referred to as being active; if, however, a liquid has to be firstly added to the material by a user it is referred to as being activatable. Suitable materials are porous materials such as foam materials, cardboard, cellulose, minerals (kieselguhr) and the like. Aqueous gels may also be used.

In order to avoid an unselective consumption of the capacity of the active material, the material should be surrounded by insulating material in such a manner that escape of moisture into the external space or gas uptake is limited to the area of the opening which serves to humidify the interior of the vessel or remove gas. This is usually the channel formed by the opening. Accordingly the insulating material should form a housing around the material which only leaves the surface of the channel and/or the surface of the cover facing the vessel interior open. Basically all materials are suitable as insulating materials which form a barrier to moisture and/or gases, especially carbon dioxide. Such materials are in particular plastics of adequate thickness, metal (metal foils) etc.

The insulating material preferably forms a housing in which the active material is located. The housing can additionally have devices for attaching the cover to a vessel opening or to the opening of a system such as a thread, a snap closure and the like.

A cover which is present in a ready-to-use state already releases moisture into the environment or absorbs gases from the environment when it is not yet mounted appropriately on a vessel or a system. Hence it is preferable to provide means which prevent exhaustion of the capacity of the cover before its intended use. For this purpose the cover can for example be stored in a closed vessel or transport bag (for example made of aluminium laminate) for delivery. Another approach is to seal the cover so that moisture cannot escape and/or gas cannot enter in such a manner that the user can simply remove the seal before using the cover. For this purpose it is for example possible to cover the openings with detachable sealing foils. In another advantageous embodiment which is particularly advantageous from a manufacturing perspective, pierceable foils are used to close the opening from the external space. The cover can be activated before use by piercing the foil. The piercing can for example be carried out manually by the user or by a piercing device in an analyzer. A pipetting needle of adequate thickness can for example also serve as such a piercing device.

The above-mentioned problem of an unintentional consumption of the capacity of the covers can also be avoided by firstly preparing the cover to release moisture and/or take up gas shortly before it is used. This is for example possible when the material of the cover is able to take up a moisture releasing or gas absorbing liquid but does not yet contain this liquid before an activation. In such an embodiment the material can be impregnated with a suitable liquid by the user or by instruments (preferably in an analyzer) in order to activate the cover. For such an activation the user can for example also place a cover for a short period in a dish containing an alkaline solution such that the liquid penetrates into the material via the opening. After removing the cover and removing liquid residues, the cover can be used as intended.

A reactivation can also be carried out using the same procedure when the active material is consumed or its capacity has been reduced.

In the case of arrangements of several vessels it is possible to provide only one cover instead of individual covers for individual vessels, which has a plurality of openings which correspond to the vessel openings through which the individual vessels can be accessed.

The covers of the present invention can also be advantageously combined with the chimneys known in the prior art for evaporation reduction. For this purpose a tube can for example be attached to the underside of the housing such that the inside of the tube forms an extension of the channel in the cover. As a result of this combination of covers and chimneys the evaporation or the uptake of gases can be limited to a smaller volume so that the positive effects complement each other.

### BRIEF DESCRIPTION OF THE DRAWINGS

The present invention is elucidated in more detail by the figures:

FIG. 1: Cross-sectional view of a vessel with cover

FIG. 2: Cross-sectional view of an arrangement of vessels with a cover having several openings

FIG. 3: System with a storage space in cross-section

### DESCRIPTION OF THE INVENTION

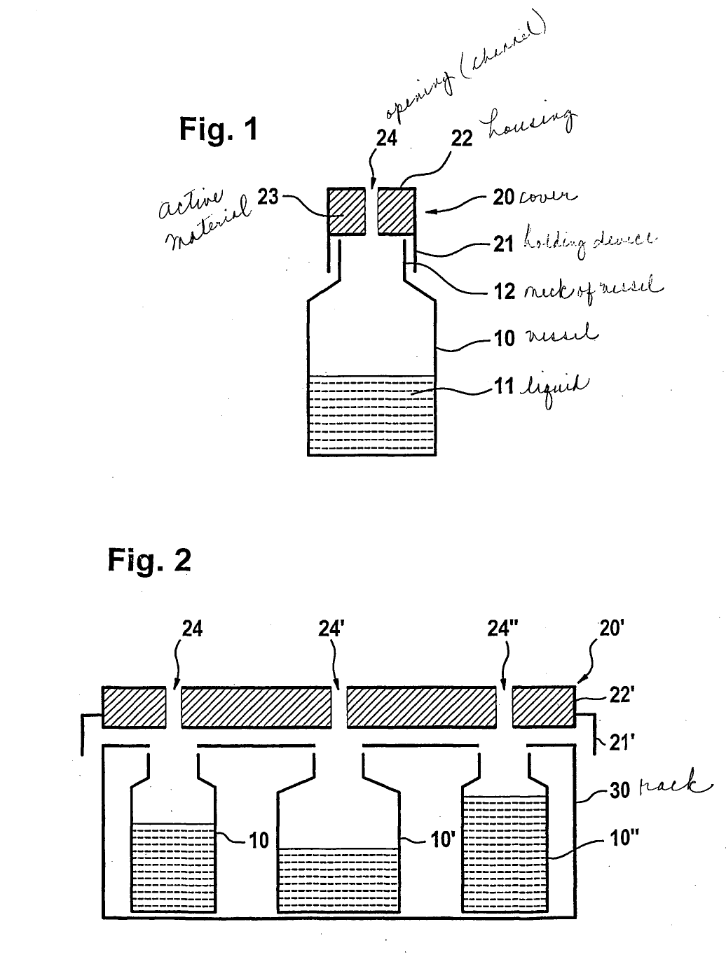

FIG. 1 shows a system for storing liquids which has a vessel (10) containing a liquid (11). A cover (20) for reducing evaporation of the liquid (11) from the vessel and for reducing the uptake of carbon dioxide by the liquid (11) is attached to the vessel opening. The vessel opening is in the neck of the vessel (12) which has an external thread (not shown). The cover (20) has a holding device (21) in the shape of a cylinder which extends downwards and has an internal thread (not shown). The cover also has a housing (22) which seals the active material (23) from the external space in such a manner that moisture can only escape from the active material (23) or gases can only be absorbed through the area of the opening (24) of the cover. In this figure the opening (24) is in the form of a channel or a hole through the cover. In this example the channel has a length of 1 cm and has a cross-section of 5 mm. Gas exchange takes place via the exposed surface of the channel. In addition the underside of the housing (22) can be completely or partially open to enable gas exchange between the active material (23) and the vessel interior. In the case shown the underside of the housing is, however, closed apart from the opening to prevent the active material (23) from being pressed out when the cover is attached to the vessel opening. The cover of FIG. 1 can be formed in a very simple manner from two conventional screw caps by filling a first screw cap with an absorbent material that is usually used for flower arrangements and closing the opening of the first screw cap with the upper side of a second screw cap by gluing, welding and the like. An axial hole can now be drilled through the resulting arrangement to form the opening. The cover is activated by briefly placing it in an aqueous or alkaline solution.

FIG. 2 shows a system for storing liquids which contains three vessels. Such racks in which several reagent containers are combined to form a functional unit are for example known from EP B 0 564 970. The three vessels shown in FIG. 2 (10, 10′, 10″) are in a rack (30) which serves to hold the vessels. The upper side of the rack has openings which correspond to the vessel openings. This arrangement which is known from EP B 0 564 970 is complemented according to the invention by a cover which reduces evaporation from the vessels or uptake of gases. The cover (20′) shown in FIG. 2 has three openings (24, 24′, 24″) which are arranged such that the contents of the vessels can be accessed through them with a pipette or the like. The cover shown in FIG. 2 also has a housing (22′) which reduces unintentional release of moisture from the vessels or uptake of gases from the outer space. It can be seen that the cover of FIG. 2 is designed as one piece such that individual separate covers for the individual vessels are not necessary. The cover additionally has holding devices (21′), with locking hooks which engage in corresponding holes in the rack to attach the cover to the rack. In contrast to the schematic representation in FIG. 2, the cover is attached to the rack in such a manner that gas can only be exchanged between the inside of the rack or the interiors of the vessels and the external space via the openings in the cover. The holding devices on the cover are designed such that gas exchange via the area of attachment is effectively prevented.

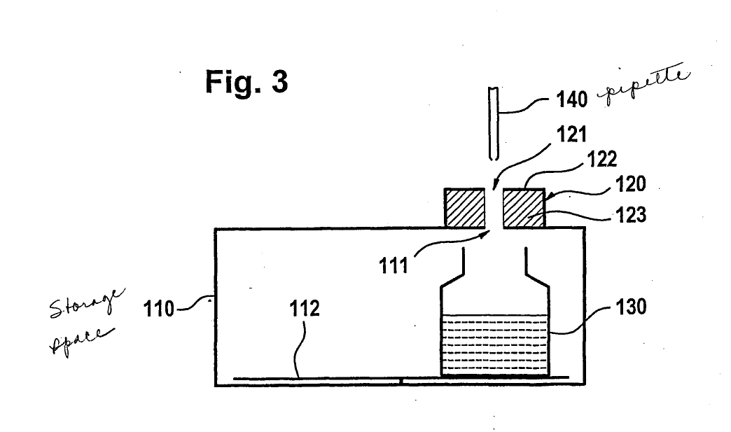

FIG. 3 shows a storage space (110) in the form of a cylinder which has an opening (111) on its upper side. The opening is closed by a cover (120) to reduce release of moisture and/or uptake of carbon dioxide in such a manner that gas exchange between the storage space and the outer space can only take place via an opening (121) in the cover. The cover (120) has a housing which is connected to the storage space by means of locking elements (not shown) and preferably such that the cover can be simply manually replaced. An absorbent material is present in the interior of the housing (122) which is impregnated with water or sodium hydroxide solution. A rotor plate (112) on which several vessels are arranged is located within the storage space. A vessel (130) can be sequentially moved by rotation to a withdrawal position (vessel position shown in FIG. 3) below the opening of the device in order to withdraw liquid from these vessels. A pipette (140) is inserted through the opening (121) into the vessel interior in order to withdraw liquid.

What is claimed is:

1. A cover (20, 20′) for a vessel (10) for reducing the evaporation of a liquid from the vessel and/or the introduction of gases, especially of carbon dioxide, into a liquid (11) in the vessel, wherein the cover has at least one through opening (24) through which a pipette or another device can be inserted into the interior of the vessel from the outer space and the cover contains a material (23) which has taken up a liquid such that it releases moisture and/or absorbs gas.

2. The cover of claim 1, further comprising an attachment means (21, 21′) for attaching the cover (20, 20′) to the vessel (10) or to a rack (30).

3. The cover of claim 2, in which the attachment means is a thread for screwing it onto the thread of a vessel.

4. The cover of claim 1, wherein the material is an absorbent substance which is impregnated with an aqueous liquid.

5. The cover of claim 4, wherein the aqueous liquid is alkaline in order to absorb carbon dioxide as well as to release moisture.

6. The cover of claim 1, wherein the material is surrounded by a housing (22) in such a manner that an escape of moisture into the outer space or an uptake of gases from the outer space is essentially restricted to the area of the opening.

7. The cover of claim 1, wherein the ends of the at least one opening (24, 24′, 24″) are closed prior to using the cover.

8. The cover of claim 7, wherein the opening is closed by a pierceable material.

9. The cover of claim 1, wherein a tube is connected to the opening which protrudes into the vessel when the cover is attached to the vessel for its intended use.

10. A system for storing liquids comprising a vessel (10, 10′, 10″) and a cover attached to the vessel (20, 20′) for reducing the evaporation and/or the introduction of gases, especially carbon dioxide, into a liquid in the vessel, the cover having at least one opening (24, 24′, 24″) through which a pipette or the like can be inserted into the vessel interior, wherein the cover contains a material (23) which has taken up a liquid such that it releases moisture and/or absorbs gas.

11. The system of claim 10, wherein the vessel contains a reagent liquid.

12. The system of claim 10, which has a rack (30) for holding two or more vessels and wherein the at least one cover (20′) has openings (24, 24′, 24″) which correspond to the vessel openings.

13. A system with a cover for reducing the evaporation of liquids from vessels and/or the introduction of gases, especially carbon dioxide, comprising a storage space (110) for holding at least one vessel (130) and a cover (120) with at least one opening (121), the cover containing a material (123) which has taken up a liquid such that it releases moisture and/or absorbs gas, wherein the cover is arranged on the storage space in such a manner that gas flows through the opening when gas is exchanged between the storage space and the outer space and the cover releases moisture and/or removes gases and is also arranged such that a pipette (140) or another device can be inserted through the at least one opening into the at least one vessel.

14. The system of claim 13, wherein the material is impregnated with a liquid which releases moisture and/or absorbs carbon dioxide.

15. The system of claim 14, wherein the material is surrounded by an insulating material in such a manner that the escape of moisture into the outer space or the uptake of gases from the outer space is essentially limited to the area of the opening.

16. The system of claim 13, wherein the storage space has a transport device (112) which can be used to position the vessels in the storage space in such a manner that a pipette or another device can be inserted through the at least one opening into a vessel positioned for this purpose.

17. The system of claim 13, which has at least one closure device which can close the opening in such a manner that no gas exchange takes place between the device and the outer space.
